(19) United States
(12) Patent Application Publication
(10) Pub. No.: US 2025/0088574 A1
(43) Pub. Date: Mar. 13, 2025

(54) INTERFACE TO CONTROL UNIT OF A VEHICLE

(71) Applicant: GM Cruise Holdings LLC, San Francisco, CA (US)

(72) Inventors: Aniket Ratnakar, Chino Hills, CA (US); ShuTing Guo, San Francisco, CA (US)

(73) Assignee: GM Cruise Holdings LLC, San Francisco, CA (US)

(21) Appl. No.: 18/463,775

(22) Filed: Sep. 8, 2023

(51) Int. Cl. H04L 69/08; B60W 60/00; G07C 5/00; H04L 9/40

(52) U.S. Cl. CPC H04L 69/08; B60W 60/00; G07C 5/008; H04L 63/0428; B60W 2556/45

(57) ABSTRACT

A unified electronic control unit (ECU) interface provides a bridge from ECU clients to the ECU. The ECU interface may be implemented on a vehicle's onboard computer, and it may be used by clients executing on the onboard computer and, in some cases, by clients outside the onboard computer. The ECU interface may receive a request from a client in a first messaging format, e.g., a local networking protocol used by processes running on the vehicle. The ECU interface translates the request into a second messaging format and transmits the request to the ECU. The ECU interface receives a response from the ECU and translates the response into the first messaging format for delivery to the client. The ECU interface may further perform authentication of the client and/or the ECU, packet serialization of the response from the ECU, packet diagnostics, and other functionalities associated with communicating with the ECU.

### TECHNICAL FIELD OF THE DISCLOSURE

The present disclosure relates generally to computer systems for autonomous vehicles and, more specifically, to interfacing with an electronic control unit (e.g., an engine control unit) of an autonomous vehicle.

### BACKGROUND

Autonomous vehicles (AVs) include a variety of connected devices and systems that enable the AV to drive autonomously. For example, AVs often include multiple sensor systems (e.g., cameras, radar, and lidar), computers running various software processes (e.g., image detection, routing, path planning), and components for controlling AV movement (e.g., engine control, brake control, steering control). Various hardware and software components communicate over internal networks on the AV, e.g., to exchange data and transmit instructions.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a block diagram illustrating a system, including an example AV that may implement a unified interface to an electronic control unit (ECU), according to some embodiments of the present disclosure;

FIG. 2 is a block diagram illustrating various computing components that may be included in an AV, according to some embodiments of the present disclosure;

FIG. 3 is a block diagram illustrating an ECU interface and various other components that may be included in an onboard computer and data flow between such components, according to some embodiments of the present disclosure;

FIG. 4 is a block diagram illustrating an example implementation of the ECU interface in the onboard computer, according to some embodiments of the present disclosure; and

FIG. 5 is a flow chart of a process for interfacing with an ECU, according to some embodiments of the present disclosure.

### DESCRIPTION OF EXAMPLE EMBODIMENTS OF THE DISCLOSURE

### Overview

The systems, methods and devices of this disclosure each have several innovative aspects, no single one of which is solely responsible for all of the desirable attributes disclosed herein. Details of one or more implementations of the subject matter described in this specification are set forth in the description below and the accompanying drawings.

AVs rely on complex hardware and software systems to perform autonomous driving. For example, an AV may have various onboard sensor systems that gather data about the AV's current behavior and the environment around the AV. AVs also execute a large number of software processes, including processes to analyze data from the onboard sensors, and processes to make driving decisions based on the analyzed data. AVs further include various control systems that control driving and other functionality.

These functionalities may be segmented into various components on the AV. For example, one computing device may implement an AV software stack, also referred to as an AV stack. The AV stack receives sensor data, processes the sensor data (e.g., performing sensor fusion and perception), and plans the movements of the AV based on the processed sensor data. The AV stack may further receive routing information (e.g., a destination) and perform route planning and/or path planning. In some cases, an AV includes two or more computing devices running the AV stack, e.g., a primary device and a secondary device that can be used if a fault is detected in the primary device.

The AV stack interfaces with one or more control devices that can implement commands from the AV stack to control physical hardware of the AV. The main control device for implementing driving instructions from the AV stack is often referred to as an electronic control unit (ECU). For example, the ECU may be a computer that controls various aspects of an engine's operation; this may be referred to as an engine control unit, which may also be abbreviated ECU. For example, if a vehicle has an internal combustion engine, the ECU may control fuel injection, ignition timing and air-fuel ratio, based on various inputs, such as engine speed and throttle position.

In advanced vehicles, such as vehicles used for autonomous driving, the ECU may include additional functionalities and/or control additional AV systems. For example, the ECU may control the transmission (where an electronic control unit for an engine and transmission may be referred to as a powertrain control unit), brakes, suspension, central timing, doors, windows, locks, etc. As another example, in an EV, the ECU may manage the high-voltage battery, control power distribution to the electric motor and power flow to other components, control the motor's speed and torque, control regenerative braking, perform thermal management, and perform other control functionalities. In different implementations, ECUs may be referred to using different names, such as battery management system (BMS) for an EV. The ECU may also store information relating to the AV, such as vehicle identification number (VIN), an ECU identification number, etc. As used herein, ECU should be understood to refer generally to an electronic control unit, where one example of an electronic control unit is an engine control unit (and thus, the ECU discussed herein may be an engine control unit in some embodiments).

As described above, the AV stack executes on a computing device in the AV, which may be referred to as an onboard computer. The onboard computer may execute additional software processes, such as software for authenticating the AV to one or more external systems, software for launching the AV stack on the onboard computer, software for enabling communications with the AV, etc. In addition, the AV may include additional computing devices outside of the onboard computer and ECU which may interface with the ECU. The processes running on the onboard computer and/or off the onboard computer that interface with the ECU are referred to as ECU clients, or simply clients.

In some cases, the ECU may use a different networking protocol from other devices in the AV, such as the onboard computer and other client devices. For example, communications from the ECU may have a certain packet format, and require specific authentication protocols, diagnostic tools, and packet extraction methods; one or more of these aspects (and possibly others) can be collectively define a protocol. While the AV stack is running, other clients may use the AV stack as an interface to the ECU. However, in some situations, other clients may have reason to interface with the ECU at times that the AV stack is not running. In prior vehicle architectures, this required each client to implement an independent interface with the ECU. For example, each other component that may access the ECU while the AV stack is not running may have a custom library to manage communications with the ECU; these custom libraries are difficult to set up and maintain and can lead to potential issues. For example, if the networking protocol used by the ECU changes, each interface would need to be independently modified. As another example, different interfaces may be programmed with different levels of rigor, e.g., one interface may lack a safety check that another interface has, which is undesirable.

As described herein, a unified ECU interface provides a bridge between ECU clients and an ECU. The ECU interface may be implemented on the onboard computer, and it may be used by clients on the onboard computer and, in some cases, by clients outside the onboard computer. In some embodiments, if an AV includes multiple onboard computers (e.g., a primary onboard computer and a backup onboard computer), each onboard computer may implement an identical ECU interface. If an AV includes multiple identical ECUs (e.g., a primary ECU and a backup ECU), a unified interface may be able to connect to any of the ECUs, e.g., via a switch between the onboard computer and the ECUs.

The ECU interface may receive a request for a client in a first messaging format, e.g., a request using a local networking protocol used by devices or processes running on the AV. The ECU interface translates the request into a second messaging format (e.g., a format for the networking protocol used by the ECU) and transmits the request to the ECU. The ECU interface receives a response from the ECU and translates the response into the first messaging format for delivery to the client. The ECU interface may further perform authentication of the client and/or the ECU, packet serialization of the response from the ECU, packet diagnostics, and other functionalities associated with communicating with the ECU.

In some embodiments, the onboard computer further implements a web server that may sit between the ECU interface and one or more clients. In some embodiments, certain clients may communicate via hypertext transfer protocol (HTTP). The web server may receive an HTTP request (e.g., a GET request) and provide a request in the first messaging format to the ECU interface. The web server may further provide an HTTP response to the client, based on a response from the ECU interface.

As will be appreciated by one skilled in the art, aspects of the present disclosure, in particular aspects of a unified interface between an ECU and client devices and/or processes, described herein, may be embodied in various manners (e.g., as a method, a system, a computer program product, or a computer-readable storage medium). Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Functions described in this disclosure may be implemented as an algorithm executed by one or more hardware processing units, e.g. one or more microprocessors, of one or more computers. In various embodiments, different steps and portions of the steps of each of the methods described herein may be performed by different processing units. Furthermore, aspects of the present disclosure may take the form of a computer program product embodied in one or more computer-readable medium(s), preferably non-transitory, having computer-readable program code embodied, e.g., stored, thereon. In various embodiments, such a computer program may, for example, be downloaded (updated) to the existing devices and systems (e.g. to the existing perception system devices and/or their controllers, etc.) or be stored upon manufacturing of these devices and systems.

The following detailed description presents various descriptions of specific certain embodiments. However, the innovations described herein can be embodied in a multitude of different ways, for example, as defined and covered by the claims and/or select examples. In the following description, reference is made to the drawings where like reference numerals can indicate identical or functionally similar elements. It will be understood that elements illustrated in the drawings are not necessarily drawn to scale. Moreover, it will be understood that certain embodiments can include more elements than illustrated in a drawing and/or a subset of the elements illustrated in a drawing. Further, some embodiments can incorporate any suitable combination of features from two or more drawings.

The following disclosure describes various illustrative embodiments and examples for implementing the features and functionality of the present disclosure. While particular components, arrangements, and/or features are described below in connection with various example embodiments, these are merely examples used to simplify the present disclosure and are not intended to be limiting. It will of course be appreciated that in the development of any actual embodiment, numerous implementation-specific decisions must be made to achieve the developer's specific goals, including compliance with system, business, and/or legal constraints, which may vary from one implementation to another. Moreover, it will be appreciated that, while such a development effort might be complex and time-consuming; it would nevertheless be a routine undertaking for those of ordinary skill in the art having the benefit of this disclosure.

In the Specification, reference may be made to the spatial relationships between various components and to the spatial orientation of various aspects of components as depicted in the attached drawings. However, as will be recognized by those skilled in the art after a complete reading of the present disclosure, the devices, components, members, apparatuses, etc. described herein may be positioned in any desired orientation. Thus, the use of terms such as “above”, “below”, “upper”, “lower”, “top”, “bottom”, or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, and/or conditions, the phrase “between X and Y” represents a range that includes X and Y.

Other features and advantages of the disclosure will be apparent from the following description and the claims.

### Example AV System

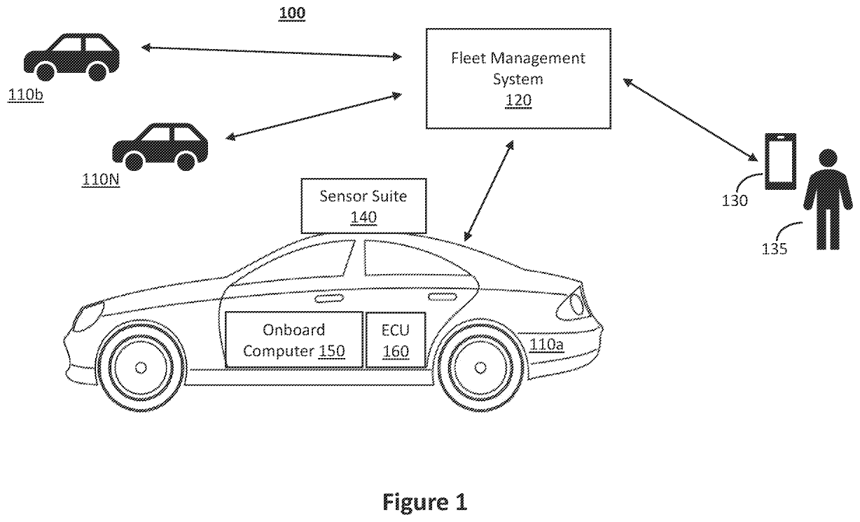

FIG. 1 is a block diagram illustrating a system 100 including an example AV that may implement a unified interface to an ECU, according to some embodiments of the present disclosure. The system 100 may include a fleet of autonomous vehicles (AVs) 110, including AV 110a, AV 110b, and AV 110N, a fleet management system 120, and a user device 130. For example, a fleet of AVs may include a number N of AVs, e.g., AV 110a through AV 110N. AV 110a may include a sensor suite 140, an onboard computer 150, and an ECU 160. AVs 110b through 110N may also include the sensor suite 140, onboard computer 150, and ECU 160. A single AV in the fleet is referred to herein as AV 110, and the fleet of AVs is referred to collectively as AVs 110.

The AV 110 may be a fully autonomous automobile, but may additionally or alternatively be any semi-autonomous or fully autonomous vehicle; e.g., a boat, an unmanned aerial vehicle, a self-driving car, etc. Additionally, or alternatively, the AV 110 may be a vehicle that switches between a semi-autonomous state and a fully autonomous state and thus, the AV may have attributes of both a semi-autonomous vehicle and a fully autonomous vehicle depending on the state of the vehicle.

The AV 110 includes a sensor suite 140, which includes a computer vision (“CV”) system, localization sensors, and driving sensors. For example, the sensor suite 140 may include photodetectors, cameras, radar (radio detection and ranging), sonar (sound detection and ranging), lidar (light detection and ranging), GPS (global positioning system) sensors, wheel speed sensors, inertial measurement units (IMUs), accelerometers, microphones, strain gauges, pressure monitors, barometers, thermometers, altimeters, etc. The sensors may be located in various positions in and around the AV 110.

An onboard computer 150 is connected to the sensor suite 140 and functions to control the AV 110 and to process sensed data from the sensor suite 140 and/or other sensors in order to determine the state of the AV 110. Based upon the vehicle state and programmed instructions, the onboard computer 150 modifies or controls the behavior of the AV 110. For example, the onboard computer 150 maneuvers the AV 110 according to routing selections determined by an onboard or remote navigation system.

The onboard computer 150 is preferably a general-purpose computer adapted for I/O communication with vehicle control systems and sensor suite 140, but may additionally or alternatively be any suitable computing device, or a group of computing devices. The onboard computer 150 may transmit data to and receive data from other AV components via one or more local networks on the AV. The onboard computer 150 is preferably connected to the Internet via a wireless connection (e.g., via a cellular data connection). Additionally or alternatively, the onboard computer 150 may be coupled to any number of wireless or wired communication systems.

The AV 110 further includes an ECU 160 that provides vehicle control signals to the engine and/or other control systems of the AV 110 based on instructions or information from the onboard computer 150. For example, the ECU 160 may provide a throttle interface that controls an engine throttle, motor speed (e.g., rotational speed of electric motor), or any other movement-enabling mechanism; a brake interface that controls brakes of the AV 110 (or any other movement-retarding mechanism); and a steering interface that controls steering of the AV 110 (e.g., by changing the angle of wheels of the AV 110). The ECU 160 may additionally or alternatively provide control of any other vehicle functions, e.g., windshield wipers, headlights, turn indicators, air conditioning, etc.

The onboard computer 150 and/or other onboard computing devices communicate with the ECU 160, e.g., to provide instructions to the ECU 160 and to retrieve data from the ECU 160. The onboard computer 150 may implement an ECU interface that enables one or more clients on the onboard computer 150 or on another device transmit messages (e.g., requests) to the ECU 160 and receive messages (e.g., responses to the requests) from the ECU 160. In some embodiments, the AV 110 includes redundant components, e.g., a primary device and a backup device that is identical to the primary device, or a primary device and multiple backups. For example, the AV 110 may include two onboard computers 150 (e.g., a primary onboard computer and a backup onboard computer) and two ECUs 160 (e.g., a primary ECU and a backup ECU). The AV 110 may include other redundancies, e.g., redundant sensor systems.

The fleet management system 120 manages the fleet of AVs 110. The fleet management system 120 may manage a service that provides or uses the AVs 110, e.g., a service for providing rides to users with the AVs 110, or a service that delivers items, such as prepared foods, groceries, or packages, using the AVs 110. The fleet management system 120 may select an AV from the fleet of AVs 110 to perform a particular service or other task and instruct the selected AV (e.g., AV 110a) to autonomously drive to a particular location (e.g., a pickup address or a delivery address). The fleet management system 120 may select a route for the AV 110 to follow. The fleet management system 120 also may manage fleet maintenance tasks, such as charging and servicing of the AVs 110.

As shown in FIG. 1, each of the AVs 110 may communicate with the fleet management system 120. The AVs 110 and fleet management system 120 may connect over a public network, such as the Internet. More specifically, the fleet management system 120 may receive and transmit data via one or more appropriate devices and network from and to the AV 110, such as by wireless systems, such as a wireless local area network (WLAN) (e.g., an IEEE 802.11 based system), a cellular system (e.g., a wireless system that utilizes one or more features offered by the 3rd Generation Partnership Project (3GPP), including General Packet Radio Service (GPRS)), and the like.

The user device 130 may be a personal device of the user 135, e.g., a smartphone, tablet, computer, or other device for interfacing with a user of the fleet management system 120. The user device 130 may provide one or more applications (e.g., mobile device apps or browser-based apps) with which the user 135 can interface with a service that provides or uses AVs. The service, and the AVs 110 associated with the service, may be managed by the fleet management system 120, which may also provide the application to the user device 130. In other embodiments, the service may be managed by a separate system (e.g., a food delivery service) that relies on the AV fleet for some or all of its transportation tasks and interacts with the fleet management system 120 to arrange transportation tasks.

### Example AV Computing Components

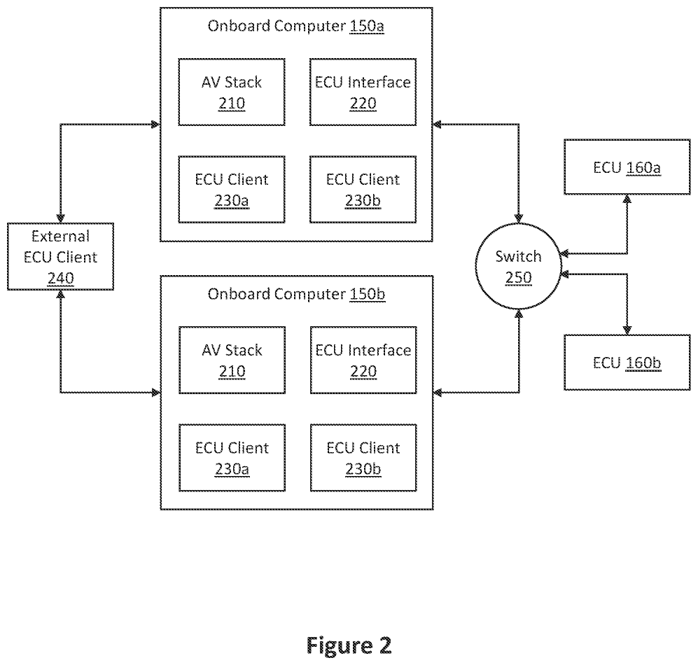

FIG. 2 is a block diagram illustrating various computing components that may be included in an AV 110, according to some embodiments of the present disclosure. In this example, the AV 110 includes two onboard computers 150a and 150b. For example, onboard computer 150a may be a primary onboard computer that ordinarily controls operation of the AV 110, while onboard computer 150b may be a backup onboard computer. If a fault is detected in the primary onboard computer 150a, the AV 110 may switch over to the backup onboard computer 150b, so that the backup onboard computer 150b controls operation of the AV 110.

Each of the onboard computers 150a and 150b (referred to jointly as onboard computers 150) have an identical set of components. In this example, each of the onboard computers 150 implements an AV stack 210, an ECU interface 220, and two ECU clients 230a and 230b (referred to jointly as ECU clients 230). The onboard computers 150 may have additional components, e.g., additional ECU clients 230, that are identical between the two onboard computers 150a and 150b. The components 210-230 of each onboard computer 150 are implemented as software programs or software modules that execute on the onboard computer 150. Instructions for executing the software programs or modules may be stored on a memory accessible to the onboard computer 150, e.g., an integrated memory of each onboard computer 150, or a separate memory device coupled to one or both of the onboard computers 150.

The AV 110 further includes two ECUs 160a and 160b. For example, ECU 160a may be a primary ECU that ordinarily receives and implements instructions from the onboard computer 150 (e.g., the onboard computer 150a), while ECU 160b may be a backup ECU. If a fault is detected in the primary ECU 160a, the AV 110 may switch over to the backup ECU 160b, so that the backup ECU 160b implements the instructions from the onboard computer 150.

In this example, a switch 250 couples the two onboard computers 150a and 150b to the two ECUs 160a and 160b. The switch 250 may be configurable to couple the primary onboard computer 150a to either of the ECUs 160a or 160b, and to couple the backup onboard computer 150b to either of the ECUs 160a or 160b, depending on the operational status of the onboard computers 150 and ECUs 160. In some embodiments, the switch 250 includes hardware and/or software for detecting faults in the onboard computers 150 and/or the ECUs 160, and the switch 250 may include decision logic (implemented as hardware and/or software) for setting a switch position, i.e., to select a particular onboard computer 150 and a particular ECU 160. In other embodiments, the fault detection and/or decision logic are performed by a different device or devices.

While the example of FIG. 2 includes two onboard computers 150a and 150b and two ECUs 160a and 160b, in other examples, the AV 110 may include a single instance of either the onboard computer 150 or the ECU 160, or more than two instances of the onboard computers 150 and/or ECUs 160. The switch 250, or a set of switches, may be adapted based on the hardware of the AV 110.

In another embodiment, each onboard computer 150 may be coupled to a dedicated ECU 160, i.e., the primary onboard computer 150a may be coupled to the primary ECU 160a, and the backup onboard computer 150b may be coupled to the backup ECU 160b. If a fault is detected in either the primary onboard computer 150a or the primary ECU 160a, the AV 110 may switch to the backup onboard computer 150b and the backup ECU 160b.

As noted above, each onboard computer 150 implements an AV stack 210, an ECU interface 220, and two ECU clients 230. The AV stack 210 is coupled to the sensor suite 140 (not depicted in FIG. 2) and receives sensor data from the sensor suite 140. The AV stack 210 processes the sensor data, e.g., by performing object detection and classification algorithms based on data from one or more of the sensors. The AV stack 210 plans the movements of the AV 110 based on the processed sensor data and additional data, such as data representing a detailed map of the current environment of the AV 110 and data about the current state of the AV 110. The AV stack 210 may further receive routing information (e.g., a destination or a waypoint) and perform route planning and/or path planning based on the routing information.

The AV stack 210 may have an interface with the ECU 160 (in this case, the currently-operating ECU 160a or 160b coupled to the currently-operating onboard computer 150a or 150b by the switch 250). The AV stack 210 may provide instructions to the ECU 160 based on the planned path over the AV stack's dedicated interface. For example, if the AV stack 210 determines that the AV 110 is to slow down approaching an intersection, the AV stack 210 may provide instructions to the ECU 160 describing the speed and direction for the AV 110. The ECU 160 translates these instructions into vehicle control signals for one or more components, e.g., control signals to the engine to reduce power delivered by the engine and control signals to perform regenerative braking.

The onboard computers 150 each provide an ECU interface 220 that may be used by other components of the onboard computers 150, i.e., the ECU clients 230a and 230b, to interface with the ECU 160. In particular, the ECU interface 220 of the operating onboard computer 150a or 150b can interface with the ECU 160a or 160b selected by the switch 250. In some embodiments, the ECU interface 220 runs when the AV stack 210 is not running, e.g., when the AV 110 is parked or charging. In some embodiments, the ECU interface 220 continues to run while the AV stack 210 is up. In some embodiments, the AV stack 210 relies on the ECU interface 220 for at least a portion of communications between the AV stack 210 and the ECU 160. For example, the AV stack 210 may transmit and/or receive time-critical messages over its dedicated interface to the ECU 160, and transmit and/or receive less time-critical messages via the ECU interface 220.

The ECU interface 220 provides a bridge between the ECU clients 230 and the ECU 160. For example, the ECU interface 220 receives a request from an ECU client 230 in a first messaging format, e.g., a request using a local networking protocol used within the AV 110. The ECU interface 220 translates the request into a second messaging format, e.g., a format for the networking protocol used by the ECU 160. For example, the ECU 160 may transmit and receive messages in user datagram protocol (UDP).

The ECU interface 220 transmits the request in the second messaging format to the ECU 160. The ECU interface 220 receives a response from the ECU 160 and translates the response into the first messaging format for delivery to the client. The ECU interface 220 may further perform authentication of the client and/or the ECU 160, packet serialization of the response from the ECU 160, packet diagnostics, packet and/or data validation, and other functionalities associated with communicating with the ECU 160. For example, the ECU interface 220 may be programmed to communicate with the ECU 160 based on specific requirements of the ECU 160, such as packet timeout duration. As another example, the ECU interface 220 is programmed to parse and interpret packet headers of packets sent from the ECU 160.

Furthermore, the ECU interface 220 is programmed to perform authentication of packets received from the ECU 160 and/or transmit packets encrypted or coded to the ECU 160 using a particular authentication algorithm. For example, the ECU interface 220 may be programmed to implement a cipher-based message authentication code (CMAC), keyed-hash message authentication code (HMAC), or another type of message authentication algorithm used by the ECU 160. The ECU 160 may provide a message authentication code (MAC) with the response message, and the ECU interface 220 authenticates the response based on the MAC. Likewise, the ECU interface 220 may transmit messages (e.g., requests) to the ECU 160 with a MAC, so that the ECU 160 may authenticate messages from the ECU interface 220. The ECU interface 220 may be updated based on any changes or updates to the ECU 160.

The ECU clients 230 are software processes (e.g., software programs or software modules) executed by the onboard computer 150. As one example, the ECU client 230a is an authentication process that authenticates the AV 110 to the fleet management system 120. For example, the authentication process may authenticate the AV 110 when the onboard computer 150 boots up, which may be before the AV stack 210 is launched. The authentication process (i.e., the ECU client 230a) may retrieve information from the ECU 160 via the ECU interface 220, where the information is used for authenticating the AV 110. For example, the authentication process may retrieve the vehicle identification number (VIN) of the AV 110 from the ECU 160. As another example, the authentication process may retrieve an ECU identifier that may be used to determine whether the primary ECU 160a or the backup ECU 160b is operating. In some cases, the authentication process may access additional information from the ECU, such as data indicating whether the AV 110 is moving.

As another example, the ECU client 230b is a software module or program for launching the AV stack 210, also referred to as a launch application. The launch application may interface with the fleet management system 120 and/or other outside systems. The launch application may retrieve information for launching the AV stack 210, such as information identifying which ECU 160 is operating. The onboard computer 150 may include additional and/or alternative ECU clients 230.

The example ECU clients 230a and 230b execute on the onboard computer 150. In some embodiments, one or more additional or alternative clients implemented outside of the onboard computer 150 may also interface with the ECU 160 (in particular, the operating ECU 160a or 160b) via the ECU interface 220 of the onboard computer 150 (in particular, the ECU interface 220 of the operating onboard computer 150a or 150b). FIG. 2 further includes an example of an external ECU client 240 that can communicate with either of the onboard computers 150a and 150b. In other embodiments, the AV 110 may include two identical instances of the external ECU client 240, one coupled to the onboard computer 150a and another coupled to the onboard computer 150b. The first instance may operate while the onboard computer 150a is controlling the AV 110, and the second instance may operate while the onboard computer 150b is controlling the AV 110.

In one example, the external ECU client 240 is a telematics gateway that provides a network interface between the AV 110 and the fleet management system 120, e.g., to transmit vehicle telematics to the fleet management system 120. The telematics gateway may connect to a cellular network and/or other wireless network(s). The telematics gateway may further receive signals (e.g., routing instructions) from the fleet management system 120 over the network. In one example, the telematics gateway retrieves information from the ECU 160 via the ECU interface 220, and the telematics gateway transmits the retrieved information to the fleet management system 120.

In another example, the external ECU client 240 is a gateway that provides an interface between the AV 110 and external device, e.g., an interface that can be accessed by a laptop inside the AV 110 or outside the AV 110 that is used by a member of the operations team. The member of the operations team may access AV information via this gateway, e.g., VIN, ECU identifier, onboard computer identifier, engine status (e.g., whether the engine is operating to move the AV 110, or the AV 110 is stationary), door lock status, etc.

### Example ECU Interface Environment In The Onboard Computer

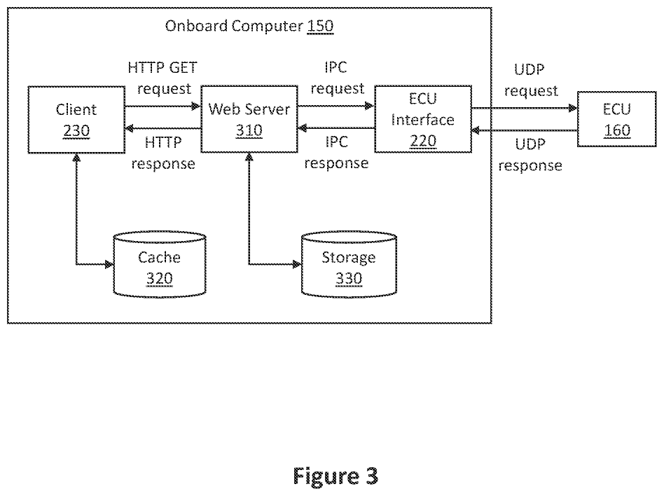

FIG. 3 is a block diagram illustrating an ECU interface 220 and various other components that may be included in an onboard computer 150, and data flow between such components, according to some embodiments of the present invention. In this example, the onboard computer 150 includes the ECU interface 220, a client 230 (e.g., one of the clients 230a or 230b of FIG. 2), a web server 310, a cache 320, and storage 330. The ECU interface 220 is in communication with the ECU 160. In alternative configurations, different, fewer, and/or additional components may be included in the onboard computer 150. For example, as shown in FIG. 2, the onboard computer 150 includes the AV stack 210 and may include additional client devices not specifically shown in FIG. 3.

In this example, the web server 310 is coupled between the client 230 and the ECU interface 220. The web server 310 may be included to enable communications between certain clients (e.g., the client 230a) and the ECU interface 220, if the client uses a different communication protocol from other systems of the onboard computer 150. Other clients (e.g., the client 230b) may communicate directly with the ECU interface 220, rather than through the web server 310. Furthermore, while the client 230 coupled to the web server 310 in this example is a client running on the onboard computer 150, in some embodiments, one or more external clients 240, such as the external clients described above, are coupled to the web server 310.

In the example shown in FIG. 3, the client 230 and the web server 310 communicate using HTTP. The client 230 transmits an HTTP GET request to the web server 310. The HTTP GET request asks the web server 310 to send a particular resource, e.g., a VIN stored by the ECU 160. The web server 310 receives the GET request and translates it into an inter-process communication (IPC) request. The IPC request may be in a messaging format or protocol used within the onboard computer 150. The ECU interface 220 receives the IPC request and translates it into a UDP request. In this example, the ECU 160 is configured for communications using UDP. The ECU interface 220 transmits the UDP request to the ECU 160.

The ECU 160 provides the data requested in the HTTP GET request in the form of a UDP response. The ECU interface 220 receives the UDP response and translates it into an IPC response. The ECU interface 220 outputs the IPC response to the web server 310. The web server 310 receives the IPC response and translates it into an HTTP response. The web server 310 provides the HTTP response that includes the requested information (e.g., the VIN) to the client 230.

The client 230 may further be coupled to a cache 320. The client 230 may store data retrieved from the ECU 160 via the web server 310 and ECU interface 220 in the cache 320. For example, if the client 230 retrieves the VIN of the AV 110 from the ECU 160, the client 230 may store the retrieved VIN in the cache 320. If, at a later time, the client 230 wants to know the VIN, the client 230 may retrieve the stored VIN from the cache 320.

Likewise, the web server 310 may further be coupled to storage 330. The storage 330 may be a cache or a more permanent storage or memory. The web server 310 may store data retrieved from the ECU 160 via the ECU interface 220 in the storage 330. For example, if the web server 310 retrieves the VIN of the AV 110 from the ECU 160 for a first client (e.g., the client 230a), the web server 310 may store the retrieved VIN in the storage 330. If, at a later time, a second client (e.g., the client 230b, or the external client 240) requests the VIN, the web server 310 may retrieve the stored VIN from the storage 330 and return the retrieved VIN to the second client. This may provide a faster response than re-requesting the VIN from the ECU 160.

### Example Implementation of the ECU Interface

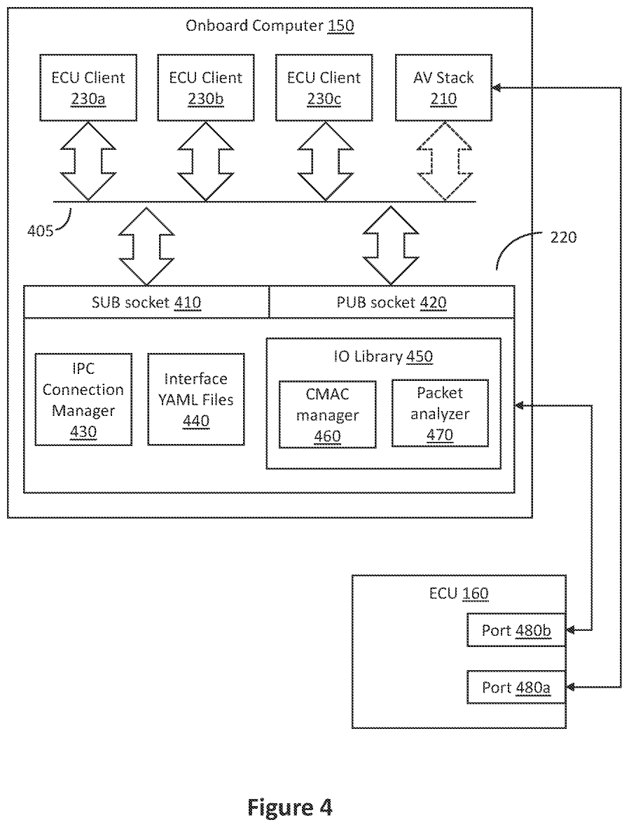

FIG. 4 is a block diagram illustrating an example implementation of the ECU interface in the onboard computer, according to some embodiments of the present invention. In this example, the onboard computer 150 includes three ECU clients 230a-230c, which are examples of the ECU clients 230 described above, the AV stack 210, and the ECU interface 220. The ECU clients 230, AV stack 210, and ECU interface 220 are coupled to a network 405 that enables inter-process communications, i.e., communications between different processes or applications running on the onboard computer 150. The AV stack 210 is further coupled to a first port 480a of the ECU 160. The ECU interface 220 is coupled to a second port 480b of the ECU 160.

In this example, the ECU interface 220 includes a SUB socket 410 and a PUB socket 420. The SUB socket 410, or subscribe socket 410, subscribes to messages published by other PUB sockets (e.g., PUB sockets of the ECU clients 230 and/or AV stack 210). The SUB socket 410 may include subscription filters, e.g., so that the ECU interface 220 receives messages of interest and filters out messages that are not of interest. The PUB socket 420, or publish socket 420, publishes messages to subscribers. Subscribers (e.g., SUB sockets of the ECU clients 230 and/or AV stack 210) may include subscription filters. Messages published on the network 405 may have PUB/SUB topics, which subscribers may use for filtering. While the PUB and SUB socket communication pattern is illustrated in FIG. 4, in other embodiments, different messaging frameworks may be used in other embodiments of the onboard computer 150.

The ECU interface 220 further includes an IPC connection manager 430, interface YAML files 440, and an IO library 450. In this example, the IO library 450 includes a CMAC manager 460 and a packet analyzer 470. In other examples, the IO library 450 and/or the ECU interface 220 may include additional features.

The IPC connection manager 430 may manage the SUB socket 410 and PUB socket 420 for communication over the network 405. For example, the IPC connection manager 430 may set the subscription filters of the SUB socket 410. The PUB/SUB topics (e.g., topic names and namespace) may be described in the interface YAML files 440.

The IO (input/output) library 450 provides instructions for the ECU interface 220 to communicate with the ECU 160. For example, the IO library 450 may provide instructions for formatting a request received from the SUB socket 410 into a UDP message for transmission to the ECU 160. The IO library 450 may further provide instructions for extracting the response to the request from a packet or set of packets transmitted by the ECU 160, so that the ECU interface 220 can transmit the response to the requesting client over the PUB socket 420.

The CMAC manager 460 enables a secure connection with the ECU 160. For example, the CMAC manager 460 encrypts messages transmitted to the ECU 160. The CMAC manager 460 authenticates and deciphers messages received from the ECU 160. For example, the CMAC manager 460 may detect any modification or alteration to a message transmitted from the ECU 160 to the ECU interface 220 to detect whether a message has been tampered with or corrupted. If the CMAC manager 460 does not authenticate a message (e.g., if the message has been corrupted or tampered with), the ECU interface 220 may provide an error message to the client via the PUB socket 420. The CMAC manager 460 may perform a key setup procedure with the ECU 160 prior to message transmission and receipt. As noted above, in other embodiments, different types of message authentication may be used, e.g., using symmetric or asymmetric keys.

The packet analyzer 470 performs analysis and/or diagnostics of packets received at the ECU interface 220 from the ECU 160 (referred to as incoming packets) and packets transmitted from the ECU interface 220 to the ECU 160 (referred to as outgoing packets). For example, the packet analyzer 470 may examine the contents and characteristics of individual network packets received from and/or transmitted to the ECU 160. The packet analyzer 470 may capture and record packets, decode the captured packets, and dissect the packet headers and payloads. The packet analyzer 470 may further perform performance monitoring, e.g., by analyzing latency, packet loss, and throughput, and may detect network errors.

As noted above, in this example, the AV stack 210 is coupled to a network 405 and, by extension, to the ECU interface 220, and the AV stack 210 is further coupled to a first port 480a of the ECU 160. In some cases, certain communications from the AV stack 210 to the ECU 160 and/or from the ECU 160 to the AV stack 210 may be transmitted through the port 480a, while other communications from the AV stack 210 to the ECU 160 and/or from the ECU 160 to the AV stack 210 may be transmitted through the ECU interface 220. For example, time-critical communications (e.g., instructions for controlling the engine and/or other driving components, such as brakes or steering) may be transmitted through the port 480a, while non-time critical communications may be transmitted through the ECU interface 220.

In some other embodiments, the AV stack 210 is not coupled directly to the ECU 160, and instead communicates with the ECU 160 via the ECU interface 220. In other embodiments, the AV stack 210 is not in communication with the ECU interface 220. In such embodiments, the AV stack 210 may still be coupled to the network 405, e.g., to communicate with one or more of the ECU clients 230.

Example Process for Interfacing with an ECU

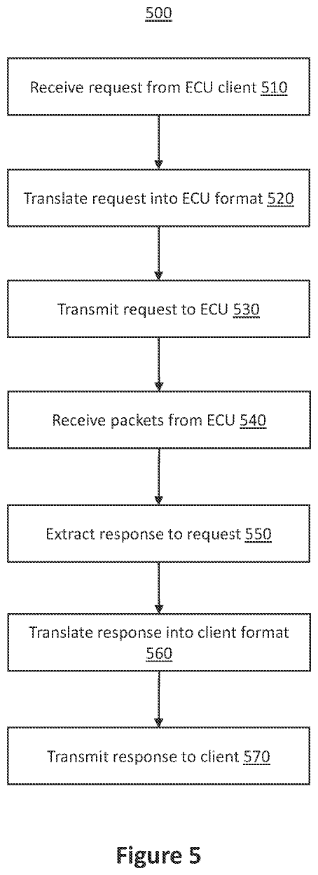

FIG. 5 is a flow chart of a process 500 for interfacing with an ECU, according to some embodiments of the present disclosure. At 510, an ECU interface executing on the onboard computer 150 of the AV 110 (e.g., the ECU interface 220) receives a request from an ECU client, e.g., one of the ECU clients 230 executing on the onboard computer 150, or an external ECU client 240. The request may be, for example, a request for information about the AV 110 (e.g., VIN number) or a request for status information (e.g., engine status of the AV 110) that the ECU 160 can provide.

At 520, the ECU interface 220 translates the request into an ECU format. As described above, the request from the ECU client may be in a first format, e.g., a format for inter-process communications of the AV 110, or an HTTP format if the request is transmitted from the client to the ECU interface 220 via a web server. The ECU interface 220 extracts the request and reformats the request into the message format or protocol used by the ECU 160.

At 530, the ECU interface 220 transmits the reformatted request to the ECU 160. As illustrated in FIG. 2, the request may be sent to one of multiple ECUs 160 in the AV 110, based on which ECU is currently operational. For example, the request may travel via a switch between the currently-operating onboard computer and the currently-operating ECU.

At 540, the ECU interface 220 receives packets from the ECU 160. One or more of the received packets include a response to the request. The ECU interface 220 may perform packet serialization and packet monitoring, e.g., to monitor the network connection between the ECU interface 220 and the ECU 160. At 550, the ECU interface 220 extracts the response from one or more of the received packets.

At 560, the ECU interface 220 translates the response into a format for transmission to the client, i.e., the first format described above. At 570, the ECU interface 20 transmits the reformatted response to the client.

### Select Examples

Example 1 provides a vehicle that includes an ECU; an onboard computer coupled to the ECU; and a non-transitory computer-readable memory storing computer program instructions executable by the onboard computer to perform operations that include receiving a first request from a client system, the client system executing on the onboard computer or another computing device in the vehicle, the first request requesting information from the ECU, the first request transmitted using a first networking protocol; transmitting a second request to the ECU for the information, the second request transmitted using a second networking protocol; receiving a response to the second request; reformatting the response to the second request; and transmitting the reformatted response to the client system, the reformatted response transmitted using the first networking protocol.

Example 2 provides the vehicle of example 1, where the first networking protocol is a local networking protocol of the vehicle, and the second networking protocol is UDP.

Example 3 provides the vehicle of example 1 or 2, the computer program instructions further including instructions to execute a web server, the web server to receive a HTTP request and to reformat the HTTP request into the first request in the first networking protocol.

Example 4 provides the vehicle of example 3, the onboard computer further including storage accessible to the web server, where, in response to a third request for the information, the web server retrieves the information from the storage.

Example 5 provides the vehicle of any of the preceding examples, where the ECU is a first ECU and the onboard computer is a first onboard computer, the vehicle further including a second ECU; a second onboard computer; and a switch, where the first ECU, the second ECU, the first onboard computer, and the second onboard computer are each coupled to the switch.

Example 6 provides the vehicle of example 5, where the client system is executing on a computing device separate from the first onboard computer and the second onboard computer, the client system is coupled to the first onboard computer and the second onboard computer, and the client system may retrieve information from the second ECU via the first onboard computer or the second onboard computer.

Example 7 provides the vehicle of any of the preceding examples, where the ECU includes at least two ports, and the onboard computer further executes an autonomous driving software stack, the autonomous driving software stack communicating with the ECU via a first port of the ECU, and the second request transmitted to a second port of the ECU.

Example 8 provides the vehicle of any of the preceding examples, the operations further including performing an authentication of the response to the second request; and reformatting the response and transmitting the reformatted response in response to the response passing the authentication.

Example 9 provides the vehicle of example 8, the operations further including, in response to a second response not passing the authentication, transmitting an error message to the client system.

Example 10 provides the vehicle of any of the preceding examples, where the client system is a vehicle authentication system, the vehicle authentication system to retrieve vehicle information from the ECU and authenticate the vehicle to an external fleet management system.

Example 11 provides a computer-implemented method for retrieving data from an ECU, the method including executing an ECU interface on an onboard computer of a vehicle; receiving, at the ECU interface, a first request from a client, the first request requesting information from the ECU, the first request transmitted using a first networking protocol; transmitting, from the ECU interface, a second request to the ECU for the information, the second request transmitted using a second networking protocol; receiving, at the ECU interface, a response to the second request; reformatting the response to the second request; and transmitting, from the ECU interface, the reformatted response to the client, the reformatted response transmitted using the first networking protocol.

Example 12 provides the method of example 11, where the ECU interface receives the first request from the client at a subscribe socket, and the ECU interface transmits the reformatted response to the second request through a publish socket.

Example 13 provides the method of example 11 or 12, further including serializing packets received from the ECU, at least one of the packets including the response to the second request; and monitoring the packets received from the ECU to detect network errors between the ECU and the ECU interface.

Example 14 provides the method of any of examples 11-13, where the response to the second request includes a message authentication code, the method further including authenticating the response to the second request based on the message authentication code.

Example 15 provides the method of any of examples 11-14, where the first networking protocol is HTTP), and the ECU interface receives the first request from the client via web server.

Example 16 provides one or more non-transitory computer-readable media storing instructions executable to perform operations, the operations including receiving a first request from a client, the first request requesting information from an ECU of a vehicle, the first request transmitted using a first networking protocol; transmitting a second request to the ECU for the information, the second request transmitted using a second networking protocol; receiving a response to the second request; reformatting the response to the second request; and transmitting the reformatted response to the client, the reformatted response transmitted using the first networking protocol.

Example 17 provides the computer-readable media of example 16, the operations including implementing a publish socket and a subscribe socket, where the first request from the client is received at the subscribe socket, and the reformatted response to the second request is transmitted through the publish socket.

Example 18 provides the computer-readable media of example 16 or 17, the operations further including serializing packets received from the ECU, at least one of the packets including the response to the second request; and monitoring the packets received from the ECU to detect network errors between the ECU and the ECU interface.

Example 19 provides the computer-readable media of any of examples 16-18, where the response to the second request includes a message authentication code, the operations further including authenticating the response to the second request based on the message authentication code.

Example 20 provides the computer-readable media of any of examples 16-19, where the first networking protocol is HTTP, and the first request from the client is received via web server.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

In one example embodiment, any number of electrical circuits of the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processors (inclusive of digital signal processors, microprocessors, supporting chipsets, etc.), computer-readable non-transitory memory elements, etc. can be suitably coupled to the board based on particular configuration needs, processing demands, computer designs, etc. Other components such as external storage, additional sensors, controllers for audio/video display, and peripheral devices may be attached to the board as plug-in cards, via cables, or integrated into the board itself. In various embodiments, the functionalities described herein may be implemented in emulation form as software or firmware running within one or more configurable (e.g., programmable) elements arranged in a structure that supports these functions. The software or firmware providing the emulation may be provided on non-transitory computer-readable storage medium comprising instructions to allow a processor to carry out those functionalities.

It is also imperative to note that all of the specifications, dimensions, and relationships outlined herein (e.g., the number of processors, logic operations, etc.) have only been offered for purposes of example and teaching only. Such information may be varied considerably without departing from the spirit of the present disclosure, or the scope of the appended claims. The specifications apply only to one non-limiting example and, accordingly, they should be construed as such. In the foregoing description, example embodiments have been described with reference to particular arrangements of components. Various modifications and changes may be made to such embodiments without departing from the scope of the appended claims. The description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the FIGS. may be combined in various possible configurations, all of which are clearly within the broad scope of this Specification.

Note that in this Specification, references to various features (e.g., elements, structures, modules, components, steps, operations, characteristics, etc.) included in “one embodiment”, “example embodiment”, “an embodiment”, “another embodiment”, “some embodiments”, “various embodiments”, “other embodiments”, “alternative embodiment”, and the like are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph (f) of 35 U.S.C. Section 112 as it exists on the date of the filing hereof unless the words “means for” or “step for” are specifically used in the particular claims; and (b) does not intend, by any statement in the Specification, to limit this disclosure in any way that is not otherwise reflected in the appended claims.

What is claimed is:

1. A vehicle comprising:
an electronic control unit (ECU) to control one or more vehicle systems;
an onboard computer coupled to the ECU; and
a non-transitory computer-readable memory storing computer program instructions executable by the onboard computer to perform operations comprising:
receiving a first request from a client system, the client system executing on the onboard computer or another computing device in the vehicle, the first request requesting information from the ECU, the first request transmitted using a first networking protocol;
transmitting a second request to the ECU for the information, the second request transmitted using a second networking protocol;
receiving a response to the second request;
reformatting the response to the second request; and
transmitting the reformatted response to the client system, the reformatted response transmitted using the first networking protocol.

2. The vehicle of claim 1, wherein the first networking protocol is a local networking protocol of the vehicle, and the second networking protocol is user datagram protocol (UDP).

3. The vehicle of claim 1, the computer program instructions further comprising instructions to execute a web server, the web server to receive a hypertext transfer protocol (HTTP) request and to reformat the HTTP request into the first request in the first networking protocol.

4. The vehicle of claim 3, the onboard computer further comprising storage accessible to the web server, wherein, in response to a third request for the information, the web server retrieves the information from the storage.

5. The vehicle of claim 1, wherein the ECU is a first ECU and the onboard computer is a first onboard computer, the vehicle further comprising:
a second ECU;
a second onboard computer; and
a switch, wherein the first ECU, the second ECU, the first onboard computer, and the second onboard computer are each coupled to the switch.

6. The vehicle of claim 5, wherein the client system is executing on a computing device separate from the first onboard computer and the second onboard computer, the client system is coupled to the first onboard computer and the second onboard computer, and the client system may retrieve information from the second ECU via the first onboard computer or the second onboard computer.

7. The vehicle of claim 1, wherein the ECU comprises at least two ports, and the onboard computer further executes an autonomous driving software stack, the autonomous driving software stack communicating with the ECU via a first port of the ECU, and the second request transmitted to a second port of the ECU.

8. The vehicle of claim 1, the operations further comprising:
performing an authentication of the response to the second request; and
reformatting the response and transmitting the reformatted response in response to the response passing the authentication.

9. The vehicle of claim 8, the operations further comprising:
in response to a second response not passing the authentication, transmitting an error message to the client system.

10. The vehicle of claim 1, wherein the client system is a vehicle authentication system, the vehicle authentication system to retrieve vehicle information from the ECU and authenticate the vehicle to an external fleet management system.

11. A computer-implemented method for retrieving data from an electronic control unit (ECU), the method comprising:
receiving, at an ECU interface, a first request from a client, the first request requesting information from the ECU, the ECU to control one or more vehicle systems, and the first request transmitted using a first networking protocol;
transmitting, from the ECU interface, a second request to the ECU for the information, the second request transmitted using a second networking protocol;
receiving, at the ECU interface, a response to the second request;
reformatting the response to the second request; and
transmitting, from the ECU interface, the reformatted response to the client, the reformatted response transmitted using the first networking protocol.

12. The method of claim 11, wherein the ECU interface receives the first request from the client at a subscribe socket, and the ECU interface transmits the reformatted response to the second request through a publish socket.

13. The method of claim 11, further comprising:
serializing packets received from the ECU, at least one of the packets comprising the response to the second request; and
monitoring the packets received from the ECU to detect network errors between the ECU and the ECU interface.

14. The method of claim 11, wherein the response to the second request comprises a message authentication code, the method further comprising authenticating the response to the second request based on the message authentication code.

15. The method of claim 11, wherein the first networking protocol is hypertext transfer protocol (HTTP), and the ECU interface receives the first request from the client via web server.

16. One or more non-transitory computer-readable media storing instructions executable to perform operations, the operations comprising:
receiving a first request from a client, the first request requesting information from an electronic control unit (ECU) of a vehicle, the ECU to control one or more vehicle systems, and the first request transmitted using a first networking protocol;
transmitting a second request to the ECU for the information, the second request transmitted using a second networking protocol;
receiving a response to the second request;
reformatting the response to the second request; and
transmitting the reformatted response to the client, the reformatted response transmitted using the first networking protocol.

17. The computer-readable media of claim 16, the operations comprising implementing a publish socket and a subscribe socket, wherein the first request from the client is received at the subscribe socket, and the reformatted response to the second request is transmitted through the publish socket.

18. The computer-readable media of claim 16, the operations further comprising:
serializing packets received from the ECU, at least one of the packets comprising the response to the second request; and
monitoring the packets received from the ECU to detect network errors between the ECU and the ECU interface.

19. The computer-readable media of claim 16, wherein the response to the second request comprises a message authentication code, the operations further comprising authenticating the response to the second request based on the message authentication code.

20. The computer-readable media of claim 16, wherein the first networking protocol is hypertext transfer protocol (HTTP), and the first request from the client is received via web server.
